(19) United States
(12) Patent Application Publication
(10) Pub. No.: US 2007/0238015 A1
(43) Pub. Date: Oct. 11, 2007

(54) Vehicular power source device

(75) Inventors: Shinya Kubota, Saitama (JP); Hideaki Sakai, Saitama (JP); Harumi Takedomi, Saitama (JP); Satoyoshi Oya, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA MOTOR CO., LTD., Tokyo (JP)

(21) Appl. No.: 11/730,738

(22) Filed: Apr. 3, 2007

(30) Foreign Application Priority Data
Apr. 5, 2006 (JP) JP2006-104152
Apr. 5, 2006 (JP) JP2006-104153

(51) Int. Cl. H01M 10/50

(52) U.S. Cl. 429/120

(57) ABSTRACT

A vehicle power source includes a number of battery modules in a first layer on one end side in a battery module laminating direction which is smaller than the number of battery modules in a fourth layer on an other end side. A cooling-air supply port is opened over the entire region in the laminating direction of the battery modules, an air-introduction guide is provided on the downstream side in the cooling-air flow direction, and a coolant discharge port is opened at a position closer to the fourth layer side. A flow from the first layer side to the fourth layer side is formed on the downstream side in the cooling-air flow direction so as to efficiently cool the battery modules difficult to be cooled.

### RELATED APPLICATION DATA

The Japanese priority application Nos. 2006-104152 and 2006-104153 upon which the present application is based are hereby incorporated, in their entirety, by reference.

### BACKGROUND OF THE INVENTION

1. Field of the Invention

The present invention relates to a vehicular power source device comprising: a battery box including a coolant supply port and a coolant discharge port; cylindrical battery modules juxtaposed in a plurality of laminated planes, in which a coolant flows in a direction orthogonal to a longitudinal direction of the battery modules, from the coolant supply port to the coolant discharge port, so as to cool the battery modules.

Also, the present invention relates to a vehicular power source device comprising: a battery box including a coolant supply port and a coolant discharge port; and a plurality of battery modules arranged in parallel are stored in the battery box, in which a coolant flows in a direction orthogonal to a longitudinal direction of the battery modules, from the coolant supply port to the coolant discharge port, so as to cool the battery modules.

### DESCRIPTION OF THE RELATED ART

Japanese Patent Application Laid-open No. 2003-152378 discloses a power source for a hybrid vehicle, in which a plurality of cylindrical battery modules juxtaposed in planes which are laminated, the battery modules are stored in the battery box, and the battery box is supported on a rear surface of a rear seat.

A cooling-air supply port and a cooling-air discharge port are provided at an upper part and a lower part of the battery box, respectively. Cooling air is supplied from the cooling-air supply port, cools the battery module while flowing through the battery box, and is discharged from the cooling-air discharge port.

Since the plurality of battery modules are electrically connected in series, if any of them is not sufficiently cooled and its temperature is raised, the life of the battery module is shortened, and further there is a problem that performance of the entire plural battery modules is lowered.

Particularly, if the number of battery modules constituting each layer is different from each other, cooling tends to be insufficient for the battery module located on the downstream side in the cooling-air flow direction in the layer with a larger number of the battery modules, leading to a problem that the temperature of the battery module is excessively raised.

Also, in forming the cooling-air supply port and the cooling-air discharge port in the battery box, if the cooling-air discharge port is displaced toward the cooling-air supply port in the direction orthogonal to the coolant flow direction, the cooling air tends to flow so as to short-circuit between the cooling-air supply port and the cooling-air discharge port. Thus, the cooling air has a difficulty in reaching a location far from the cooling-air supply port and the cooling-air discharge port, leading to a problem that the temperature of the battery module is excessively raised.

### SUMMARY OF THE INVENTION

The present invention has been achieved in view of the above circumstances, and has a first object to uniformly cool battery modules laminated in a plurality of layers in a battery box.

Also, the present invention has a second object, which is to prevent the increase of a temperature of the battery module at a location in the battery box to which a coolant has a difficulty in flowing.

In order to achieve the first object, according to a first feature of the present invention, there is provided a vehicular power source device comprising: a battery box including a coolant supply port and a coolant discharge port; cylindrical battery modules juxtaposed in a plurality of laminated planes, wherein a coolant flows in a direction orthogonal to a longitudinal direction of the battery modules, from the coolant supply port to the coolant discharge port, so as to cool the battery modules; wherein the number of the battery modules in a layer on one end side in a battery module laminating direction is smaller than the number of the battery modules in a layer on the other end side in the battery module laminating direction; and wherein the coolant discharge port is opened over the entire region in the battery module laminating direction, and the coolant discharge port is opened at a position closer to the other end side in the battery module laminating direction.

With the above arrangement, when the coolant supply port and the coolant discharge port are provided in the battery box in which a large number of cylindrical battery modules are stored in the bundled state and the coolant is caused to flow in a direction orthogonal to the longitudinal direction of the battery modules from the coolant supply port to the coolant discharge port so as to cool the battery modules, if the number of battery modules in a layer on the one end side in the laminating direction of the battery modules is set smaller than the number of battery modules in a layer on the other end side, the coolant has a difficulty in hitting on the battery modules close to the coolant discharge port among the battery modules in the layer on the other end side in the laminating direction, which lowers a cooling effect. Then, the coolant supply port is opened for the entire region in the laminating direction of the battery modules, and the coolant discharge port is opened in the position displaced toward the other end side in the laminating direction, thereby forming a flow from the one end side to the other end side in the laminating direction on the downstream side in the coolant flowing direction. Therefore, the battery modules hard to be cooled are efficiently cooled by the flow, thereby uniformly cooling all the battery modules.

According to a second feature of the present invention, in addition to the first feature, a wall surface on the one end side in the battery module laminating direction in the battery box is inclined so that a downstream side in a coolant flowing direction nears the other end side in the laminating direction.

With the above arrangement, since the wall surface on the one end side in the battery module laminating direction in the battery box is inclined so that the downstream side in the coolant flow direction nears the other end side in the laminating direction, the coolant flow direction is positively directed to the coolant discharge port, thereby more uniformly cooling all the battery modules.

According to a third feature of the present invention, in addition to the first or second feature, a recess is formed in a floor panel of a trunk room, and the battery box with the one end side in the battery module laminating direction oriented downward is stored in the recess.

With the above arrangement, since the battery box is stored in the recess formed in the floor panel of the trunk room so that the one end side in the laminating direction having a smaller number of battery modules is oriented downward, the battery box can be laid out in a compact manner in a space usually used as a space for storing a spare tire.

In order to achieve the second object, according to a fourth feature of the present invention, there is provided a vehicular power source device comprising: a battery box including a coolant supply port and a coolant discharge port; and a plurality of battery modules arranged in parallel are stored in the battery box, wherein a coolant flows in a direction orthogonal to a longitudinal direction of the battery modules, from the coolant supply port to the coolant discharge port, so as to cool the battery modules; wherein the coolant discharge port is displaced in a direction orthogonal to a coolant flow direction with respect to the coolant supply port; and wherein the power source device further comprises: a first partition wall partitioning the interior of the battery box in the direction orthogonal to the coolant flow direction; a first coolant passage defined in the battery box and displaced in the direction of displacement of the coolant discharge port with respect to the first partition wall; a second coolant passage defined in the battery box and displaced in a direction opposite from the direction of displacement of the coolant discharge port with respect to the first partition wall; a second partition wall partitioning a portion from the coolant discharge port to a downstream end of the first partition wall, and a negative pressure source for introducing the coolant to the coolant supply port by generating a negative pressure in the coolant discharge port.

With the above arrangement, when the coolant supply port and the coolant discharge port are provided in the battery box in which a plurality of battery modules arranged in parallel are stored, and the coolant flows in a direction orthogonal to the longitudinal direction of the battery module from the coolant supply port to the coolant discharge port so as to cool the battery module, if the coolant discharge port is displaced toward the coolant supply port in the direction orthogonal to the flow direction of the coolant, the coolant tends to flow to short-circuit between the coolant supply port and the coolant discharge port. Thus, the coolant has a difficulty in reaching a location far from the coolant supply port and the coolant discharge port, leading to a possibility that the temperature of the battery module rises.

Thus, the first partition wall partitioning the interior of the battery box in the direction orthogonal to the coolant flow direction is provided so as to form the first coolant passage defined in the displacement direction with respect to the first partition wall in the battery box and the second coolant passage defined on the side opposite from the displacement direction with respect to the first partition wall, whereby a negative pressure is generated by a negative-pressure generation source at the coolant discharge port leading to the downstream end of the first partition wall through the second partition wall so as to introduce the coolant to the coolant supply port. Then, the coolant introduced into the second coolant passage flows through a portion far from the coolant supply port and the coolant discharge port without short-circuiting between the coolant supply port and the coolant discharge port, and the flow is caused to efficiently work on the battery module which is hard to be cooled, thereby uniformly cooling all the battery modules.

According to a fifth feature of the present invention, in addition to the fourth feature, the first partition wall comprises a support member supporting the battery modules in the battery box.

With the above arrangement, since the first partition wall comprises the support member supporting the battery module in the battery box, a special support member for supporting the battery module can be omitted, thereby reducing the number of parts.

According to a sixth feature of the present invention, in addition to the fourth or fifth feature, the position of the coolant supply port is displaced to a side opposite from the direction of displacement of the coolant discharge port with respect to a center in the longitudinal direction of the battery modules.

With the above arrangement, since the position of the coolant supply port is displaced to the side opposite from the displacement direction with respect to the center in the longitudinal direction of the battery module, the coolant introduced from the coolant supply port can easily flow into the second coolant passage to more efficiently cool the cooled battery module hard to be cooled.

The above-mentioned object, other objects, characteristics, and advantages of the present invention will become apparent from preferred embodiments, which will be described in detail below by reference to the attached drawings.

### BRIEF DESCRIPTION OF THE DRAWINGS

FIG. 1 is a perspective view of the entirety of a vehicular power source device according to a first embodiment of the present invention;

FIG. 2 is a cross-sectional view taken along line 2-2 of FIG. 1;

FIG. 3 is a cross-sectional view taken along line 3-3 of FIG. 2;

FIG. 4 is a cross-sectional view taken along line 4-4 of FIG. 3;

FIG. 5 is a cross-sectional view taken along line 5-5 of FIG. 3;

FIG. 6 is an exploded perspective view of the vehicular power source device;

FIG. 7 is a schematic diagram showing a path through which cooling air flows;

FIGS. 8 and 9 show a second embodiment of the present invention;

FIG. 8 shows an entire perspective view of the vehicular power source device; and

FIG. 9 is a cross-sectional view taken along line 9-9 of FIG. 8.

### DETAILED DESCRIPTION OF THE INVENTION

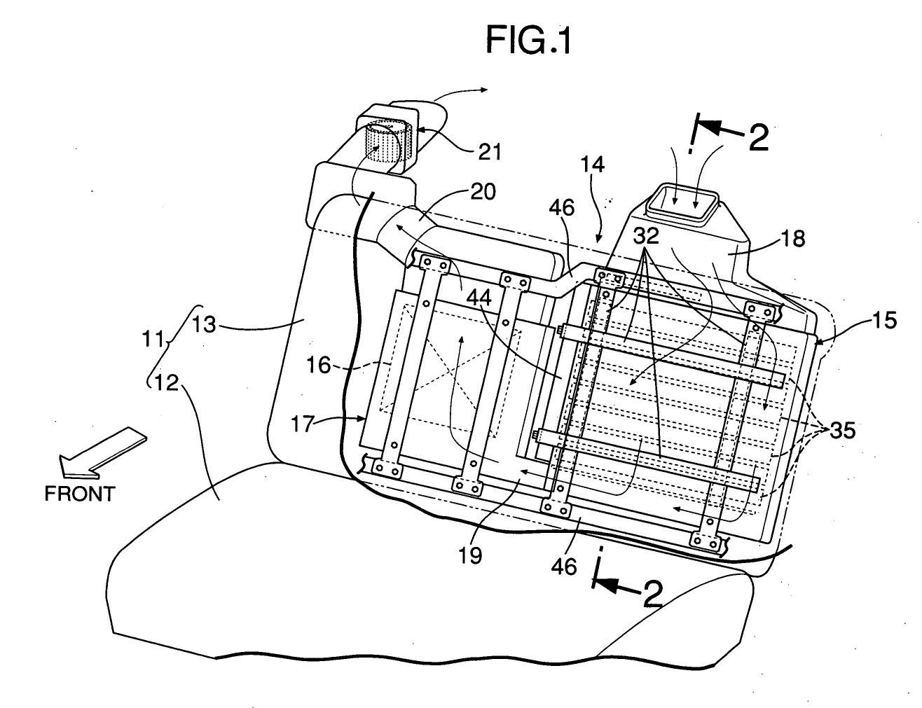

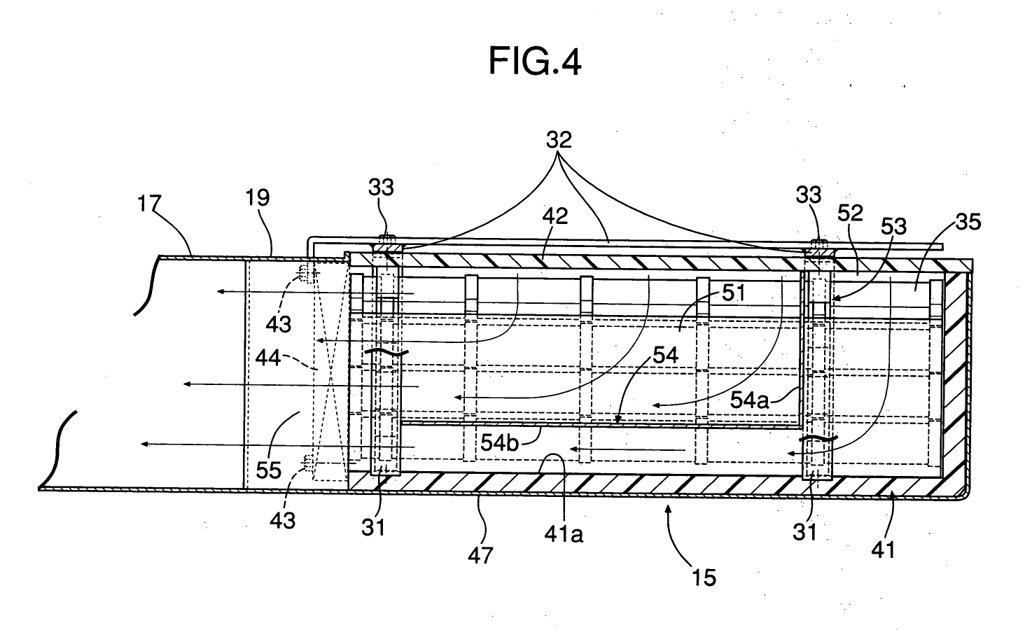

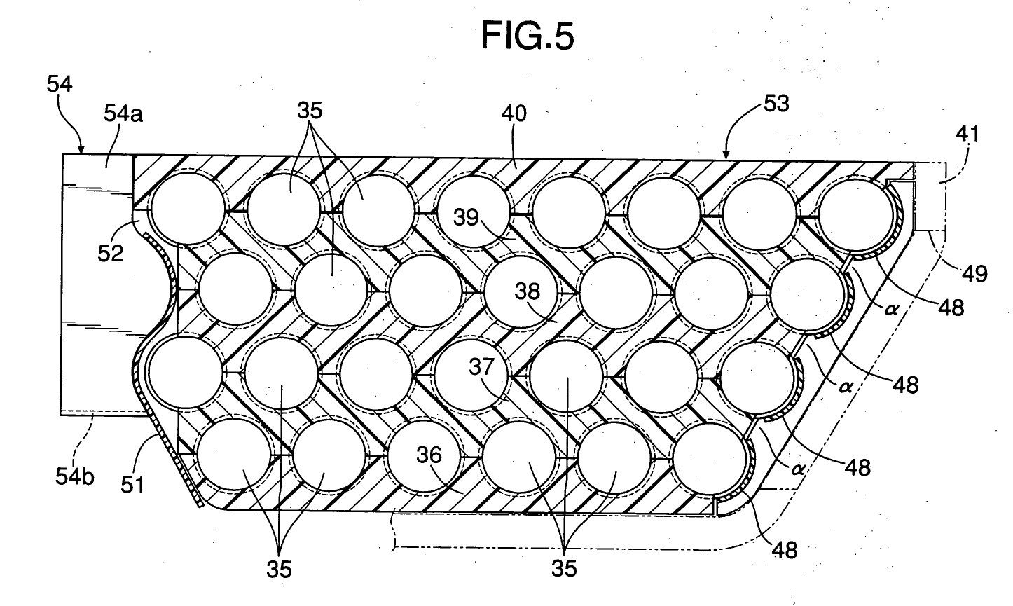

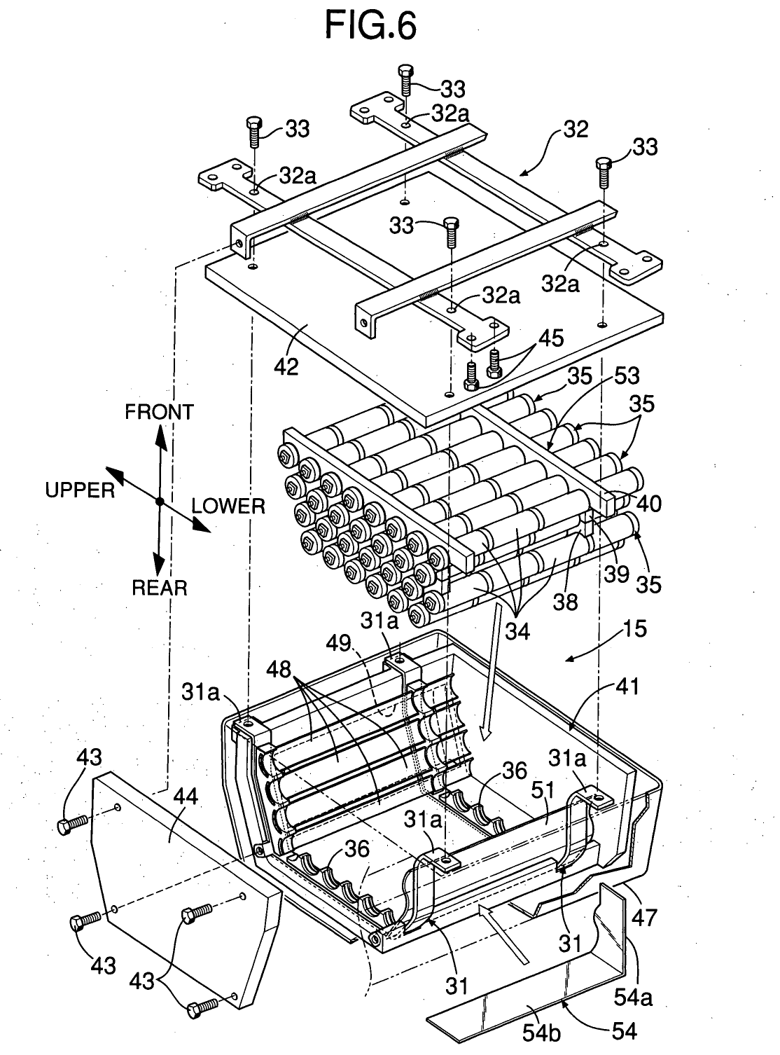

A first embodiment of the present invention will be described based on FIGS. 1 to 7.

As shown in FIG. 1, a power source device 14 is disposed on the rear face of a seat back 13, rising diagonally rearward from the rear end of a seat cushion 12 of a rear seat 11 in a hybrid vehicle having an engine and a motor generator, and is connected to THE motor generator, as a power source for driving. The power source device 14 comprises: a battery box 15 for storing a battery; an electric equipment box 17 for storing electric equipment 16, such as an inverter; a cooling-air supply duct 18 for introducing cooling air as a coolant to the battery box 15; an intermediate duct 19 for guiding the cooling air from the battery box 15 to the electric equipment box 17; a cooling-air discharge duct 20 for discharging the cooling air from the electric equipment box 17; and an electric fan 21 (a negative air pressure source) provided at the downstream end of the cooling-air discharge duct 20.

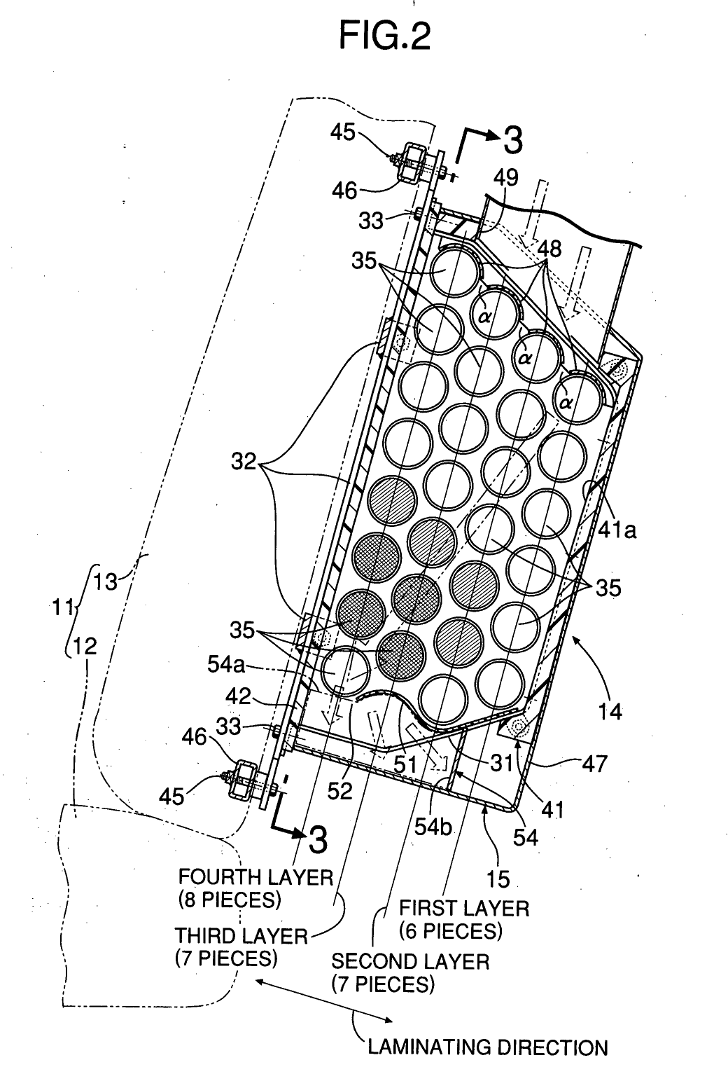

Next, the structure of the battery box 15 will be described based on FIGS. 2 to 7.

The battery box 15 comprises: a pair of battery support frames 31, 31 each formed into a U-shape; and a battery support frame 32 formed into a curb-plate shape. The opposite ends of the battery support frames 31, 31 are folded outward to form fixed portions 31a, which are integrally joined to each other by four bolts 33 penetrating through bolt holes 32a formed in the battery support frame 32.

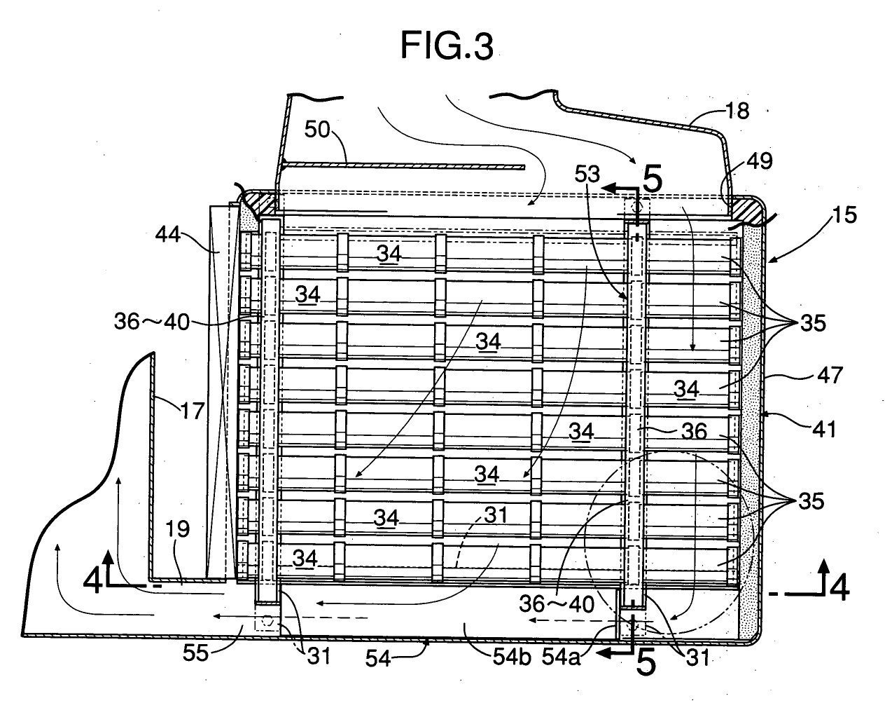

The battery stored in the battery box 15 is constituted as follows: a plurality of battery cells 34 are connected in series to form a cylindrical battery module 35; six to eight pieces of the battery modules 35 are juxtaposed in a plane; and four planes each including the battery modules 35 are laminated to constitute the battery. Five divided plate-shaped battery holders 36 to 40 are fixed respectively to the battery support frames 31, 31. One end and a portion near the other end of each battery module 35 are supported in circular openings formed in the battery holders (or support members) 36 to 40 and between the battery support frames 31, 31. Among the right and left pair of battery holders 36-40, 36-40 shown in FIG. 3, the battery holders 36-40 located on the right side constitute a first partition wall 53 of the present invention.

The peripheries of the total twenty-eight battery modules 35 integrated as described above are covered by a container-shaped battery case 41 made of polystyrene foam and a plate-shaped lid body 42 made of polystyrene foam. A junction board 44 is fixed with four bolts 43 to one of the battery support frame 31 and the battery support frame 32, and provides connection between terminals provided at one end of each battery module 35. The battery support frame 32 is fixed with eight bolts 45 to seat frames 46, 46 of the seat cushion 12. The periphery of the battery case 41 is covered by a battery cover 47 press-molded from a metal plate.

The total twenty-eight battery modules 35 are laminated in four layers. In the case where a first layer, a second layer, a third layer and a fourth layer are provided from a bottom wall (or wall surface) 41 a side of the battery case 41 to the lid body 42 side, the first layer comprises 6 battery modules 35, the second and the third layers respectively comprise 7 battery modules 35, and the forth layer comprises 8 battery modules 35. The battery modules 35 in respective layers are arranged in a staggered manner with gaps provided therebetween through which the cooling air can pass (see FIG. 2).

Four first air-introduction guides 48 having an arc-shaped section are secured to the pair of battery support frames 31, 31. The first air-introduction guides 48 are arranged so as to cover the upper surfaces of the four battery modules 35 at the upstream end in the cooling air flow direction, among the battery modules 35 in each layer. A slit α through which the cooling air can pass is formed between the adjacent first air-introduction guides 48. A cooling-air supply port (or coolant supply port) 49 is opened in the battery case 41 and the battery cover 47 so as to face the upper surfaces of the first air-introduction guides 48. The downstream end of the cooling-air supply duct 18 is connected to the cooling-air supply port 49.

A baffle plate 50 (see FIG. 3) is fixed to a portion of the cooling-air supply duct 18, in the vicinity of the downstream end thereof, so as to extend from one end (junction board 44 side) of each battery module 35 toward the other end thereof. Also, a single second air-introduction guide 51 is fixed to the pair of battery support frames 31, 31. The second air-introduction guide 51 is arranged so as to cover the lower surfaces of the three battery modules 35 at the downstream end in the cooling-air flow direction in the first to third layers among the battery modules 35 in each layer. The second air-introduction guide 51 terminates at a position opposed to the battery module 35 at the downstream end in the cooling-air flow direction in the fourth layer, and a communication port 52 is formed at this portion. Further, the bottom wall 41a of the battery case 41, facing the six battery modules 35 in the first layer (see FIG. 2), is inclined from the upstream side toward the downstream side in the cooling-air flow direction while nearing the battery modules 35.

A second partition wall 54, bent into an L-shape, is disposed at a lower part of the battery box 15. A connection portion 54a extending in the vertical direction of the second partition wall 54 is positioned on the same plane as the first partition wall 53, with the second air-introduction guide 51 therebetween. A body portion 54b extending in the horizontal direction from the connection portion 54a divides a space provided between the lower wall of the battery cover 47 and the second air-introduction guide 51 into front and rear portions.

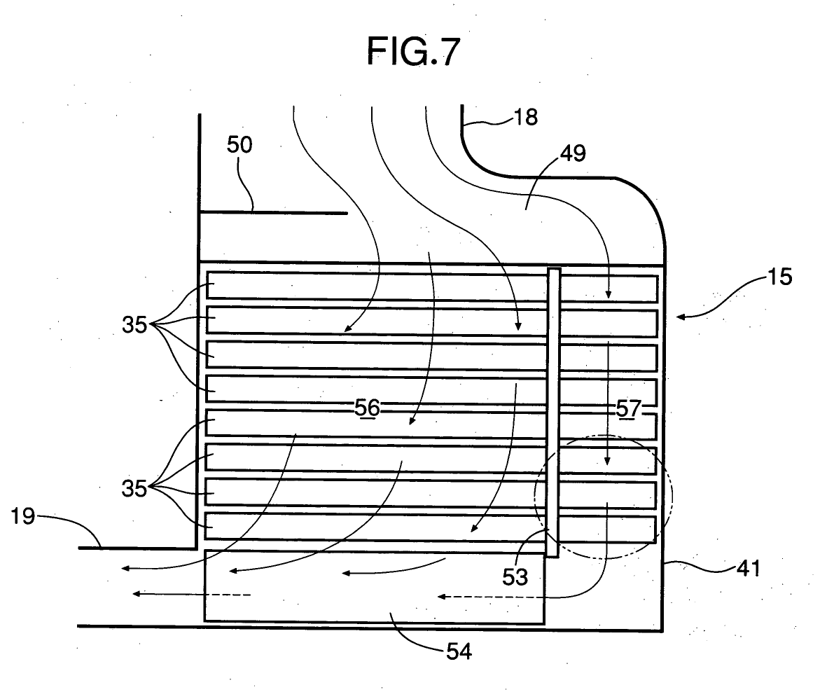

Thus, as shown in FIGS. 3 and 7, a first cooling-air passage 56 is defined on the left side (cooling-air discharge port 55 side) of the first partition wall 53, and a second cooling-air passage 57 is defined on the right side (the side opposite from the cooling-air discharge port 55) of the first partition wall 53. The streams of the cooling air pass through the first and the second cooling-air passages 56 and 57 without merging with each other, flow in the left direction in FIGS. 3 and 7 while being separated from each other by the second partition wall 54, and merges to each other at the cooling-air discharge port 55.

Next, the operation of the embodiment having the above-described structure will be described.

When the motor generator is caused to function as a motor or a generator depending on a traveling state of a vehicle, the battery modules 35 are charged and discharged, thus generating heat, and therefore they need to be cooled by cooling air. Particularly, when the electric fan 21 is driven, cooling air in a vehicle compartment is drawn from the vehicle compartment and flows through the cooling-air support duct 18, the battery box 15, the intermediate duct 19, the electric equipment box 17 and the cooling-air discharge duct 20 to the electric fan 21. In this process, the battery modules 35 in the battery box 15 and the electric equipment 16 in the electric equipment box 17 are cooled by the cooling air.

When the cooling air flows from the cooling-air supply duct 18 through the cooling-air supply port 49 into the battery box 15, the four battery modules 35 located at the upstream end in the cooling-air flow direction among the battery modules 35 in the first to the fourth layers might be over-cooled because the low-temperature cooling air forcibly contacts them. However, blocking the cooling air with the four first air-introduction guides 48 prevents the over-cooling of the four battery modules 35. The cooling air having passed through the gaps a formed between the four first air-introduction guides 48 flows through the battery box 15 toward the communication port 52 (or coolant discharge port), while contacting all the battery modules 35 to exert a cooling effect thereon.

In the cooling-air flow direction, the number of battery modules 35 is 6 in the first layer, 7 in the second and third layers, and 8 in the fourth layer, differing from each other. Therefore, there is a problem that the cooling effect is lowered for those on the downstream side in the cooling-air flow direction among the battery modules 35 in the fourth layer which has the largest number of battery modules. A similar problem, though not as serious as the fourth layer, occurs for the battery modules 35 in the second and third layers. In FIG. 2, the battery modules 35 for which cooling is the most difficult are hatched, and the battery modules 35 for which cooling is the next most difficult are shaded.

However in the embodiment, the second air-introduction guide 51 formed on the downstream side of the cooling-air flow direction of the battery box 15 can solve the above problems. Specifically, providing the second air-introduction guide 51 displaces the communication port 52 toward the fourth layer side, so that the cooling air flowing along the first layer is guided by the second air-introduction guide 51 to flow diagonally toward the communication port 52 near the fourth layer. As a result, a large amount of the cooling air can be brought into contact with the battery modules 35 shown by hatching and the battery modules 35 shown by shading, so that all the battery modules 35 are uniformly cooled, thereby improving the performance and durability of the power source device 14.

Also, since the bottom wall 41a of the battery case 41 is inclined so as to get closer to the fourth layer toward the downstream side in the cooling-air flow direction, the cooling air can easily flow diagonally toward the communication port 52, thereby further enhancing the effect of the second air-introduction guide 51.

In FIGS. 3 and 7, the cooling air supplied from the cooling-air supply duct 18 flows downward through within the battery box 15, and then changes its direction to the left by 90° to flow from right to left in the intermediate duct 19. Thus, there is a problem that the cooling air has a difficulty in hitting on the battery modules 35 located at the corner outside the biased direction of the flow (portion surrounded by a chained line circle) and the cooling effect becomes uneven.

The baffle plate 50 provided at the cooling-air supply duct 18 is to solve the above problem. The baffle plate 50 biases the cooling air flowing into the battery box 15 toward the side opposite from the intermediate duct 19 (right side in FIGS. 3 and 7), thereby supplying a sufficient amount of the cooling air to the portion surrounded by the chained-line circle to improve the cooling effect.

Further, since the first partition wall 53 comprising the battery holders 36 to 40 on the right side in FIG. 3 defines the first cooling-air passage (or first coolant passage) 56 on the left side (see FIG. 7) and the second cooling-air passage (or second coolant passage) 57 on the right side (see FIG. 7), the cooling air flowing into the second cooling-air passage 57 on the right side is not biasingly withdrawn to the left side (cooling-air discharge port 55 side), but flows straight downward through the second cooling-air passage 57 while more effectively cooling the battery modules 35 in the portion surrounded by the chained-line circle.

Also, the cooling air having passed through the first cooling-air passage 56 and the cooling air having passed through the second cooling-air passage 57 do not merge immediately, but flow independently through the rear portion and the front portion of the second partition wall 54 leading to the first partition wall 53, respectively, and then merge at a cooling-air outlet (or coolant discharge port) 55. Thus, a negative pressure generated by the electric fan 21 can be caused to uniformly act on the first cooling-air passage 56 and the second cooling-air passage 57, and a sufficient amount of the cooling air can be introduced into the second cooling-air passage 57.

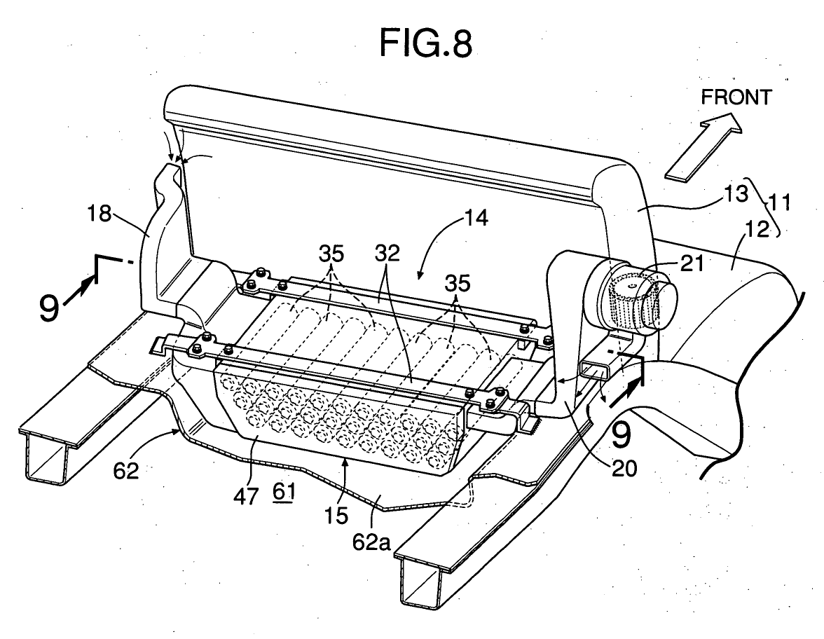

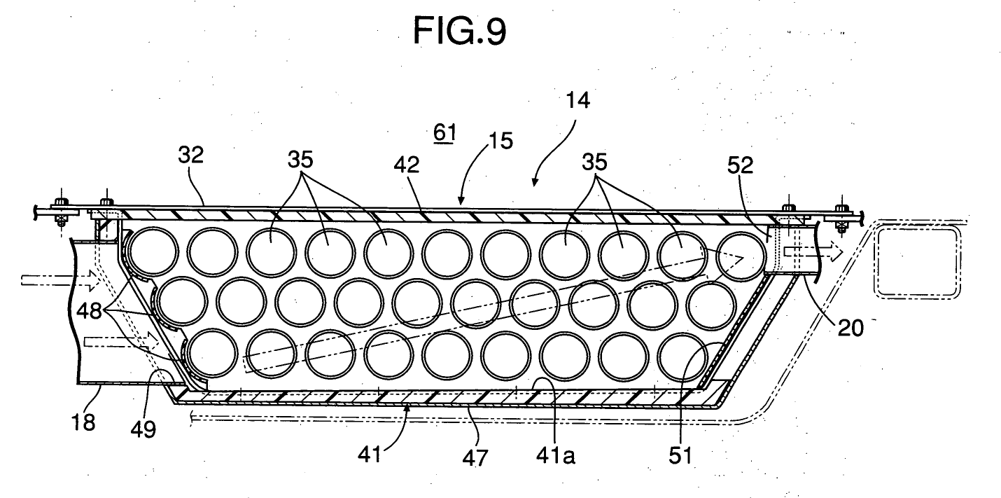

Next, a second embodiment of the present invention will be described based on FIGS. 8 and 9. Components of the second embodiment corresponding to those of the first embodiment are denoted by the same reference numerals and symbols, and the description thereof is omitted.

The power source device 14 in the second embodiment is stored in a recess 62a formed in a floor panel 62 of a trunk room 61 of an automobile. The recess 62a is a place generally used for storing a spare tire. Using this place for storing the power source device 14 enables an effective use of space.

The battery modules 35 are arranged vertically in three layers. The lower first layer comprises 9 battery modules 35, the central second layer comprises 10 battery modules 35, and the upper third layer comprises 11 battery modules 35.

The cooling-air supply duct 18 uniformly supplies the cooling air to the first to the third layers through the cooling-air supply port 49 formed in the battery case 41 of the battery box 15 and three pieces of the first air-introduction guides 48. The second air-introduction guide 51 is inclined diagonally upward on the downstream side of the cooling-air flow direction, and the bottom wall 41a of the battery case 41 is inclined so that the downstream side in the cooling-air flow direction is higher, thereby guiding the cooling air diagonally upward toward the communication port 52 opened in the vicinity of the third layer.

With this arrangement, the cooling air is effectively caused to act on the battery modules 35 located on the downstream side in the cooling air flow direction among the battery modules 35 in the third or the second layer having a larger number of battery modules thus hard to be cooled, and all the battery modules 35 can be uniformly cooled so as to improve the performance and durability of the power source device 14.

The embodiments of the present invention have been described in detail, but various changes in design can be made without departing from the subject matter thereof.

For example, the number of layers that the battery modules 35 are laminated is not limited to four or three as in the embodiments, but may be any number as long as it is plural.

Also, the number of the battery modules 35 in each layer is not limited to those of the embodiments, but may be any number as long as it is different between one end side and the other end side in the battery module laminating direction.

Further, the mounting position of the battery box 15 is not limited to the rear face of-the seat back 13 of the rear seat 11 or the recess 62a formed on the floor panel 62 in the trunk room 61, but may be any arbitrary position.

Although a specific form of embodiment of the instant invention has been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention which is to be determined by the following claims.

We claim:

1. A vehicular power source device, comprising:
a battery box including a coolant supply port and a coolant discharge port;
cylindrical battery modules juxtaposed in a plurality of laminated planes,
wherein a coolant flows in a direction orthogonal to a longitudinal direction of said battery modules, from said coolant supply port to said coolant discharge port, so as to cool said battery modules;
wherein a number of said battery modules in a layer on one end side in a battery module laminating direction is smaller than a number of said battery modules in a layer on an other end side in the battery module laminating direction; and
further wherein said coolant supply port is opened over an entire region in the battery module laminating direction, and said coolant discharge port is opened at a position closer to the other end side in the battery module laminating direction.

2. The vehicular power source device according to claim 1, wherein a wall surface on the one end side in the battery module laminating direction in said battery box is inclined so that a downstream side in a coolant flowing direction nears the other end side in the laminating direction.

3. The vehicular power source device according to claim 1, wherein a recess is formed in a floor panel of a trunk room, and said battery box with the one end side in the battery module laminating direction oriented downward is stored in said recess.

4. The vehicular power source device according to claim 2, wherein a recess is formed in a floor panel of a trunk room, and said battery box with the one end side in the battery module laminating direction oriented downward is stored in said recess.

5. A vehicular power source device, comprising:
a battery box including a coolant supply port and a coolant discharge port; and
a plurality of substantially parallel battery modules are stored in said battery box,
wherein a coolant flows in a direction orthogonal to a longitudinal direction of said battery modules, from said coolant supply port to said coolant discharge port, so as to cool said battery modules;
wherein said coolant discharge port is displaced in a direction orthogonal to a coolant flow direction with respect to said coolant supply port; and
wherein said power source device further comprises:
a first partition wall extending along the coolant flow direction for partitioning an interior of the battery box in the direction orthogonal to the coolant flow direction;
a first coolant passage defined in the battery box and displaced in the direction of displacement of the coolant discharge port with respect to the first partition wall;
a second coolant passage defined in said battery box and displaced in a direction opposite from the direction of displacement of said coolant discharge port with respect to said first partition wall;
a second partition wall partitioning a portion from said coolant discharge port to a downstream end of said first partition wall, and
a negative pressure source for introducing the coolant to said coolant supply port by generating a negative pressure in said coolant discharge port.

6. The vehicular power source device according to claim 5, wherein said first partition wall comprises a support member supporting said battery modules in said battery box.

7. The vehicular power source device according to claim 5, wherein the position of said coolant supply port is displaced to a side opposite from the direction of displacement of the coolant discharge port with respect to a center in the longitudinal direction of said battery modules.

8. The vehicular power source device according to claim 6, wherein the position of said coolant supply port is displaced to a side opposite from the direction of displacement of the coolant discharge port with respect to a center in the longitudinal direction of said battery modules.
